(19) United States
(12) Patent Application Publication
(10) Pub. No.: US 2012/0030615 A1
(43) Pub. Date: Feb. 2, 2012

(54) INFORMATION PROCESSING APPARATUS AND INFORMATION PROCESSING APPARATUS CONTROL METHOD

(75) Inventor: Hiroki Urashima, Kawasaki-shi (JP)

(73) Assignee: CANON KABUSHIKI KAISHA, Tokyo (JP)

(21) Appl. No.: 13/189,843

(22) Filed: Jul. 25, 2011

(30) Foreign Application Priority Data
Jul. 28, 2010 (JP) 2010-169699
Mar. 31, 2011 (JP) 2011-079368
May 2, 2011 (JP) 2011-103006

(51) Int. Cl. G06F 3/048

(52) U.S. Cl. 715/794

(57) ABSTRACT

In order to efficiently determine a screen to be displayed when the operation mode is changed, an information processing apparatus is provided that is configured to display a user interface (UI) screen on a display unit, and includes an acquisition unit configured to acquire data that includes a plurality of groups to which a priority level corresponding to each of a plurality of modes is set and at least one UI screen is classified into each of the plurality of groups, a storage unit configured to store the at least one UI screen classified into at least one group among the plurality of groups, an identification unit configured to identify a mode, and a display control unit configured to cause the display unit to display a UI screen that is representative of a group having a highest priority level for the mode identified.

### BACKGROUND OF THE INVENTION

1. Field of the Invention

The present invention relates to an information processing apparatus capable of shifting user interface screens and a control method therefor.

2 Description of the Related Art

On recent digital devices having multiple functions, the display screen is changed in a complicated manner. Japanese Patent Application Laid-Open No. 2002-111805 discusses a method for determining a user interface (UI) screen to be displayed on the up-front window according to a priority set to each of a plurality of UI screens to be displayed by a screen shift. There is a conventional digital multifunction peripheral (hereinafter simply referred to as an MFP) which can execute printing while shifting between color printing and monochromatic printing. An MFP like this can implement the following screen shift.

If color printing is selected, a color printing basic screen (UI screen A) is displayed. Further, when color printing is selected and the remaining amount of a color toner becomes small, the display screen is changed from the color printing basic screen (UI screen A) to a no-color toner screen (UI screen B). Furthermore, if monochromatic printing is selected when the no-color toner screen (UI screen B) is currently displayed, the display screen is changed from the no-color toner screen (UI screen B) to a monochromatic printing basic screen (UI screen C) because monochromatic printing can be executed if the remaining amount of the color toner is small.

If color printing is selected when the monochromatic printing basic screen (UI screen C) is displayed, the display screen is changed from the monochromatic printing basic screen (UI screen C) to the no-color toner screen (UI screen B). In other words, in this case, the display screen is not changed from the monochromatic printing basic screen (UI screen C) to the color printing basic screen (UI screen A) because color printing may not be appropriately executed if the remaining amount of the color toner is small.

However, the method discussed in Japanese Patent Application Laid-Open No. 2002-111805 may not always be able to implement the above-described shifting between screens. More specifically, if the priority in display is set to the UI screen B over the UI screen A and the priority is set to the UI screen C over the UI screen B, the display screen cannot be changed from the UI screen C to the UI screen A or B. On the other hand, if the priority is set to the UI screen A over the UI screen B and the UI screen A and the UI screen C have the same priority, the UI screen B is displayed preferentially to the UI screen C. Under the recent circumstances of complicated screen shifting, if a screen before shifting and a screen after shifting are determined for each input event and each application event, complicated operations may be required.

### SUMMARY OF THE INVENTION

The present invention is directed to a technique capable of efficiently determining a screen to be displayed if a function (operation mode) is changed.

According to an aspect of the present invention, an information processing apparatus configured to display a user interface (UI) screen on a display unit includes an acquisition unit configured to acquire data that includes a plurality of groups to which a priority level corresponding to each of a plurality of modes is set and at least one UI screen is classified into each of the plurality of groups, a storage unit configured to store the at least one UI screen classified into at least one group among the plurality of groups, an identification unit configured to identify a mode, and a display control unit configured to cause the display unit to display a UI screen that is representative of a group having a highest priority level for the mode identified by the identification unit among groups into which the at least one UI screen stored by the storage unit is classified.

According to an aspect of the present invention, a screen to be displayed can be efficiently determined if the function is changed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1A is a block diagram of a multifunction printer of the present invention. FIG. 1B illustrates a hardware configuration of the multifunction printer.

FIG. 2 illustrates an example of screen shift specification data.

FIG. 3 illustrates an example of screen shift specification data described in the eXtended Markup Language (XML) format.

FIG. 4 is a flow chart illustrating processing executed by a control unit.

FIGS. 5A and 5B are flow charts illustrating processing executed by the control unit.

FIGS. 6A and 6B illustrate an example of a screen shift history list stored by a history management unit.

FIG. 7A is a block diagram of a multifunction printer of the present invention. FIG. 7B illustrates a hardware configuration of the multifunction printer.

FIG. 8 illustrates an example of an operation panel of the multifunction printer.

FIG. 9 (including FIGS. 9A, 9B, and 9C) illustrates an example of screen shift specification data.

FIG. 10 is a flow chart illustrating processing executed by the control unit.

FIGS. 11A and 11B are flow charts illustrating processing executed by the control unit.

FIGS. 12A and 12B illustrate an example of a screen shift history list stored by the history management unit.

### DESCRIPTION OF THE EMBODIMENTS

Various exemplary embodiments, features, and aspects of the invention will be described in detail below with reference to the drawings.

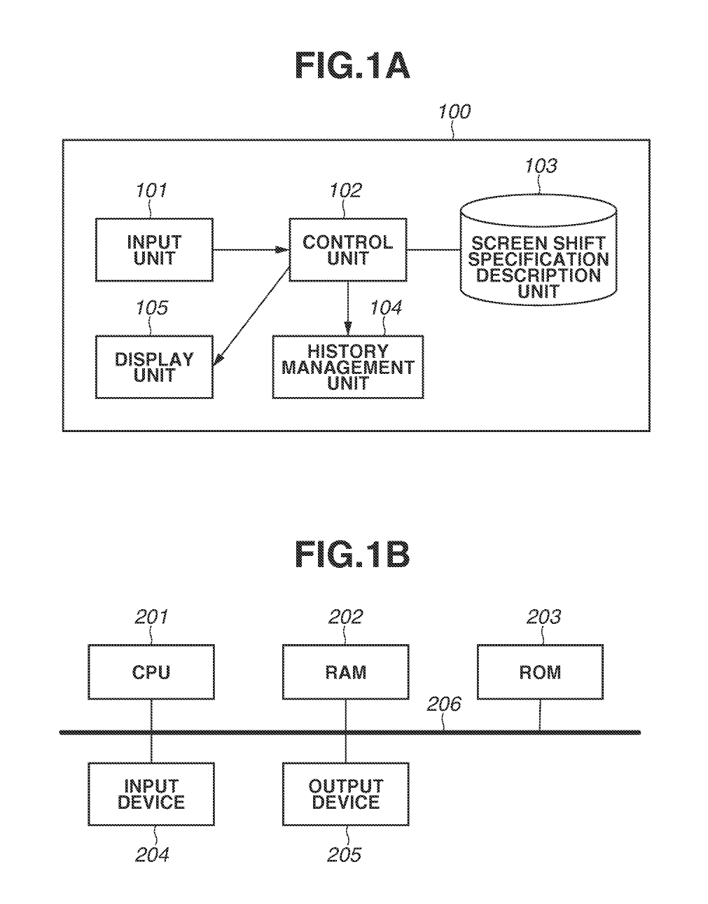

FIG. 1A is a functional block diagram of a multifunction printer, which is an example of an information processing apparatus according to a first exemplary embodiment of the present invention. Referring to FIG. 1A, the multifunction printer includes an input unit 101, a control unit 102, a screen shift specification description unit 103, a management unit 104, and a display unit 105. The input unit 101 is constituted by a plurality of buttons 204, a sensor for detecting the amount of a toner, and the like. The input unit 101 receives various user inputs and a sensor input. The control unit 102 is constituted by a central processing unit (CPU) 201 or the like. The control unit 102 reads a program and data stored in a read-only memory (ROM) 203 on a random access memory (RAM) 202 and executes various processing.

The screen shift specification description unit 103 is constituted by a storage medium, such as the ROM 203. On the screen shift specification description unit 103, screen shift specification data necessary for executing the program is stored as computer (including a CPU)-readable program codes. The management unit 104 is constituted by the RAM 202 and manages history information about a screen shift. The display unit 105 includes an output device 205, such as a liquid crystal display (LCD), and displays various information pieces including an image and text data.

FIG. 1B illustrates a hardware configuration of the multifunction printer, which is an example of the information processing apparatus according to the present exemplary embodiment. Components illustrated in FIG. 1B similar to the components of the multifunction printer described above with reference to the functional block diagram of FIG. 1A are provided with the same reference numerals and symbols. Accordingly, the description thereof will not be repeated. Referring to FIG. 1B, the multifunction printer includes a CPU 201, a RAM 202, a ROM 203, an input device 204, and an output device 205 which are in communication with one another via a system bus 206. The input device 204 includes a copy button for enabling a copy function and a facsimile (FAX) button for enabling a FAX function. The output device 205 includes a display unit, such as an LCD. The system bus 206 connects the components of the multifunction printer. Via the system bus 206, signals can be transmitted and received among the components of the multifunction printer.

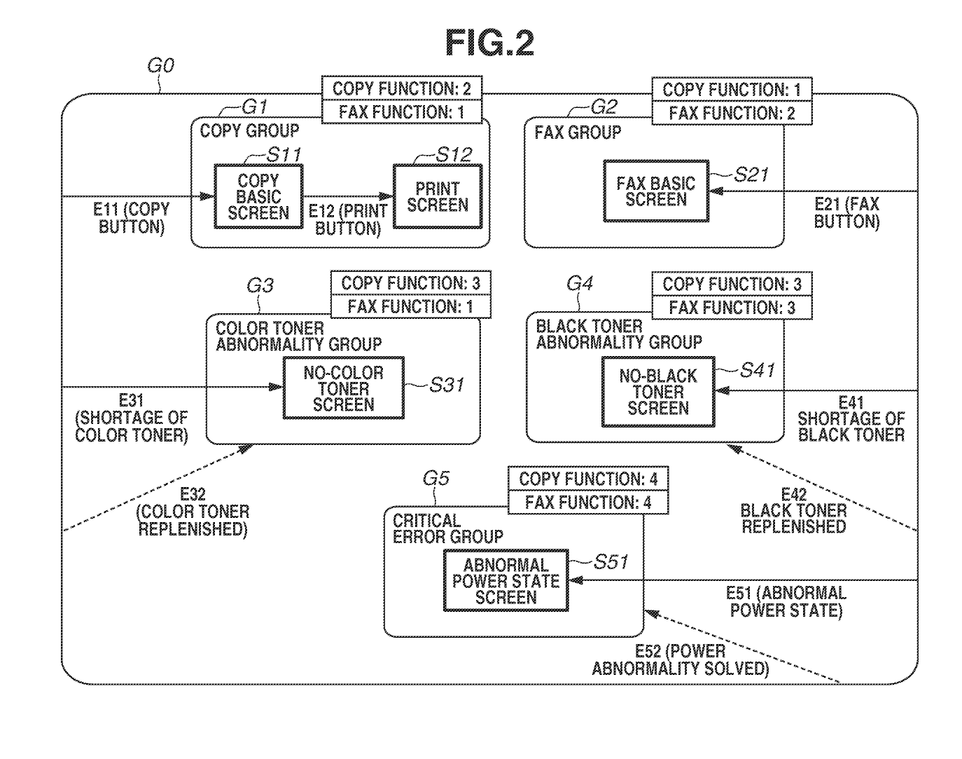

An example of screen shift executed by the multifunction printer will be described in detail below with reference to FIG. 2, which is a screen shift diagram illustrating an example of a screen shift specification. Referring to FIG. 2, the screen shift diagram includes a UI screen, a screen shift, a group (category) including one or more UI screens, and a deletion shift. The UI screen includes five screens, such as a copy basic screen S11, a print screen S12, a FAX basic screen S21, a no-color toner screen S31, a no-black toner screen S41, and a power abnormality screen S51. Each UI screen includes a UI for operating the multifunction printer.

In FIG. 2, a solid-line arrow indicates a screen shift. A broken-line arrow indicates a deletion shift. The “deletion shift” refers to processing for deleting information belonging to (grouped into) a predetermined group from screen shift history information. In executing a screen shift and a deletion shift, an action can be set. Further, in the screen shift and the deletion shift, a predetermined action is executed in response to a specific event.

The screen shift includes a screen shift executed when a copy button is pressed (event E11), a screen shift executed when a print button is pressed (event E12), and a screen shift executed when a FAX button is pressed (event E21). A screen shift executed on exceptional occasions includes a screen shift executed when a no-color toner state is detected (event E31), a screen shift executed when a no-black toner state is detected (event E41), and a screen shift executed when a power abnormality is detected (event E51). The deletion shift includes a deletion shift executed when it is detected that the no-color toner state has been solved (event E32), a deletion shift executed when it is detected that the no-black toner state has been solved (event E42), and a deletion shift executed when it is detected that the power abnormality has been solved (event E52).

In the present exemplary embodiment, a function changing action for changing the current function to the copy function is set to the event E11. Further, a function changing action for changing the current function to the FAX function is set to the event E21. These actions are set as properties of the screen shift.

The group (category) includes a copy group G1, a FAX group G2, a color toner abnormality group G3, a black toner abnormality group G4, a critical error group G5, and a group GO that includes the groups G1 through G5 as one large group. The group changes the priority according to the current function. Accordingly, the group can have priority information for each function (function-unique priority level).

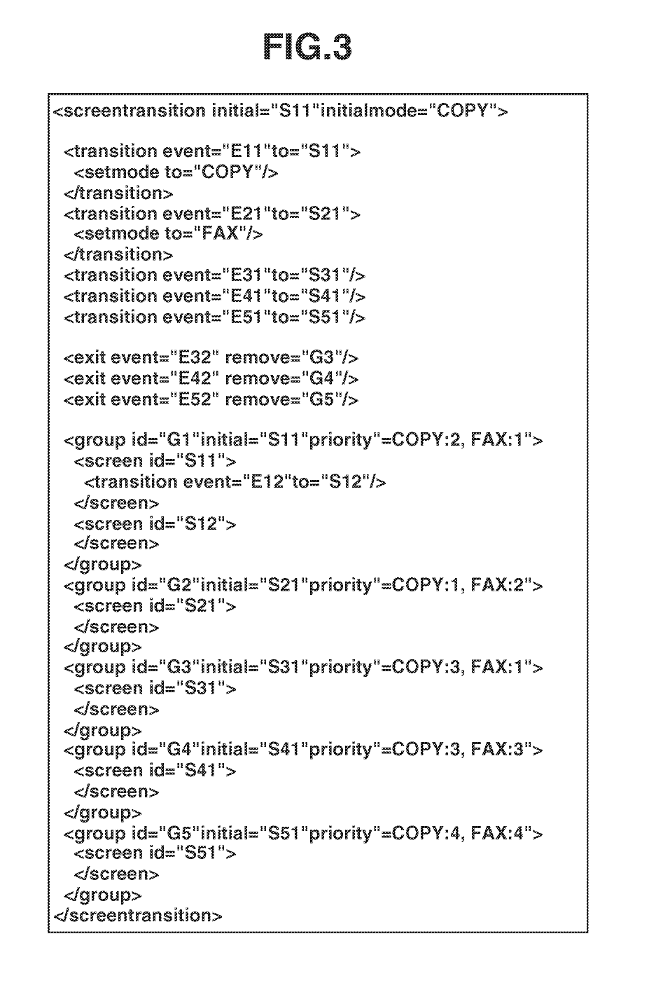

The copy group G1 has the priority level 2 for the copy function and the priority level 1 for the FAX function. Similarly, the FAX group G2 has the priority level 1 for the copy function and the priority level 2 for the FAX function. The color toner abnormality group G3 has the priority level 3 for the copy function and the priority level 1 for the FAX function. The black toner abnormality group G4 has the priority level 3 for each of the copy function and the FAX function. The critical error group G5 has the priority level 4 for each of the copy function and the FAX function. The lowest priority level is “1” and the priority level becomes higher as the numerical value for the priority level becomes greater. The screen shift specification data can be described as text data or binary data. If text data is used, the screen shift specification data is described in the XML data format illustrated in FIG. 3.

In the present exemplary embodiment, each element of screen shift specification data has the following meaning. An element <screentransition> describes a root element and corresponds to the group G0 illustrated in FIG. 2. An element <screen> describes the UI screen and is illustrated in a bold-line rectangle in FIG. 2. An element <group> describes a group and corresponds to the groups G1 through G5, which are illustrated in FIG. 2 in edge-rounded rectangles. In a priority attribute of the element <group>, the function-unique priority level is described.

An element <transition> describes the screen shift and is illustrated using a solid-line arrow in FIG. 2. An element <exit> describes the deletion shift and is illustrated using a broken-line arrow in FIG. 2. An element <setmode> describes the function changing action and is not illustrated in FIG. 2.

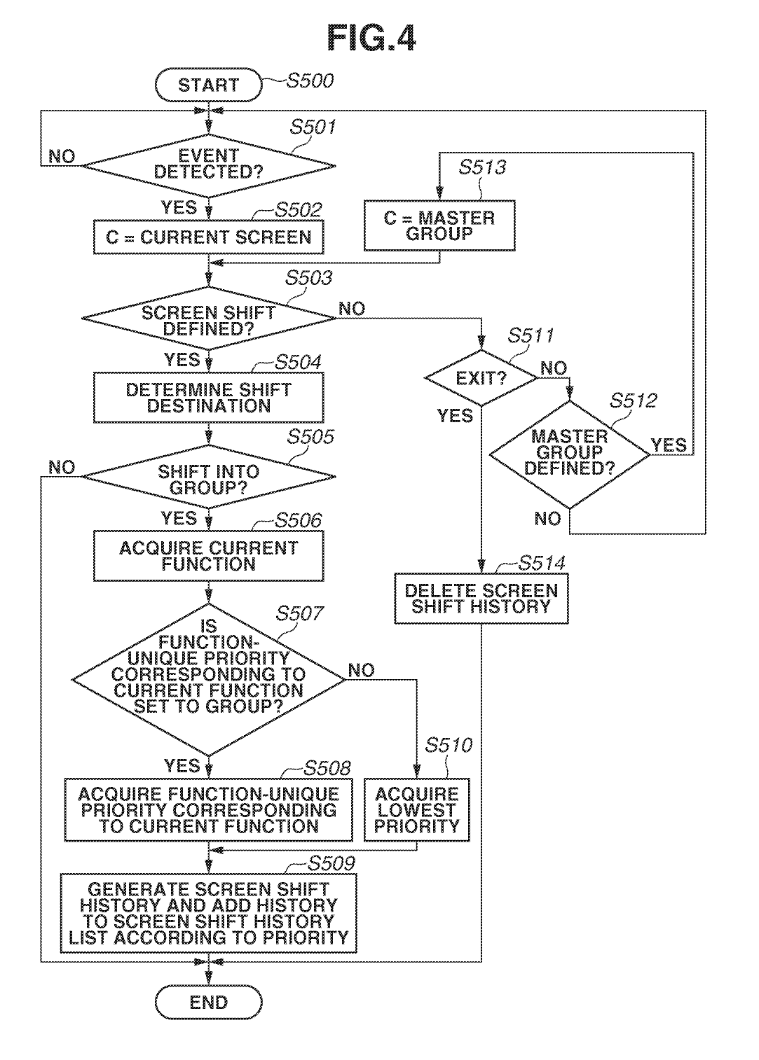

The control unit 102 loads the screen shift specification data on the RAM 202 and executes corresponding function thereon. Processing executed by the control unit 102 when an operation that is a trigger to a screen shift is detected will be described in detail below with reference to the flow chart in FIG. 4.

Referring to FIG. 4, in step S501, the control unit 102 determines whether a screen shift trigger operation (a user operation via a button or any of the above-described events) has been detected. If it is determined that a screen shift trigger operation has been detected (Yes in step S501), then the processing advances to step S502. On the other hand, if it is determined that no screen shift trigger operation has been detected (No in step S501), then the control unit 102 waits until an event is detected. In step S502, the control unit 102 sets the UI screen currently displayed on the display unit 105 (shift source UI screen) as the reference of the screen shift.

In step S503, the control unit 102 determines whether the screen shift executed according to the event detected in step S501 has been defined in the screen shift specification data with respect to the shift source UI screen. If it is determined that the predetermined data has been defined in the screen shift specification data (Yes in step S503), then the processing advances to step S504. On the other hand, if it is determined that the predetermined data has not been defined (No in step S503), then the processing advances to step S511.

In step S504, the control unit 102 determines a shift destination UI screen according to the definition in the screen shift specification data. In step S505, the control unit 102 determines whether the screen shift is a shift from the outside to the inside of the group including the shift destination UI screen. If it is determined that the screen shift is a shift into the group including the shift destination UI screen (Yes in step S505), then the processing advances to step S506. On the other hand, if it is determined that the screen shift is not a shift into the group including the shift destination UI screen (No in step S505), then the processing ends.

In step S506, the control unit 102 acquires the current function in a screen shift history list from the management unit 104. In step S507, the control unit 102 determines whether any function-unique priority level corresponding to the current function has been set to the group including the shift destination UI screen. If it is determined that a function-unique priority level corresponding to the current function has been set to the group including the shift destination UI screen (Yes in step S507), then the processing advances to step S508. If not (No in step S507), then the processing advances to step S510.

In step S508, the control unit 102 acquires the function-unique priority level corresponding to the current function. In step S510, if no function-unique priority level corresponding to the current function has been set to the group including the shift destination UI screen, the control unit 102 acquires the lowest priority level (in the present exemplary embodiment, the priority level 1).

In step S509, the control unit 102 generates a new stack-like screen shift history corresponding to the group including the shift destination UI screen and adds it to the existing screen shift history list stored in the management unit 104. A position of adding the newly generated screen shift history to the existing screen shift history list is determined according to the priority level acquired in step S508 or S510.

In step S511, the control unit 102 determines whether the deletion shift illustrated in FIG. 3 with the broken-line arrow has been defined in the screen shift specification data. If it is determined that the deletion shift has been defined (Yes in step S511), then the processing advances to step S514. On the other hand, if no deletion shift has been defined (No in step S511), then the processing advances to step S512.

In step S514, the control unit 102 deletes the screen shift history corresponding to a group to be deleted from the screen shift history list managed by the management unit 104. Then the processing ends.

In step S512, the control unit 102 determines whether a master group has been defined for the shift source UI screen. If it is determined that a master group has been defined for the shift source UI screen (Yes in step S512), then the processing advances to step S513. On the other hand, if no master group has been defined (No in step S512), then the processing returns to step S501 and the control unit 102 waits until an event is detected.

In step S513, the control unit 102 sets the detected master group as the reference of the screen shift. Then the control unit 102 executes the processing in step S503 and beyond under determination that the master group is the shift source UI screen.

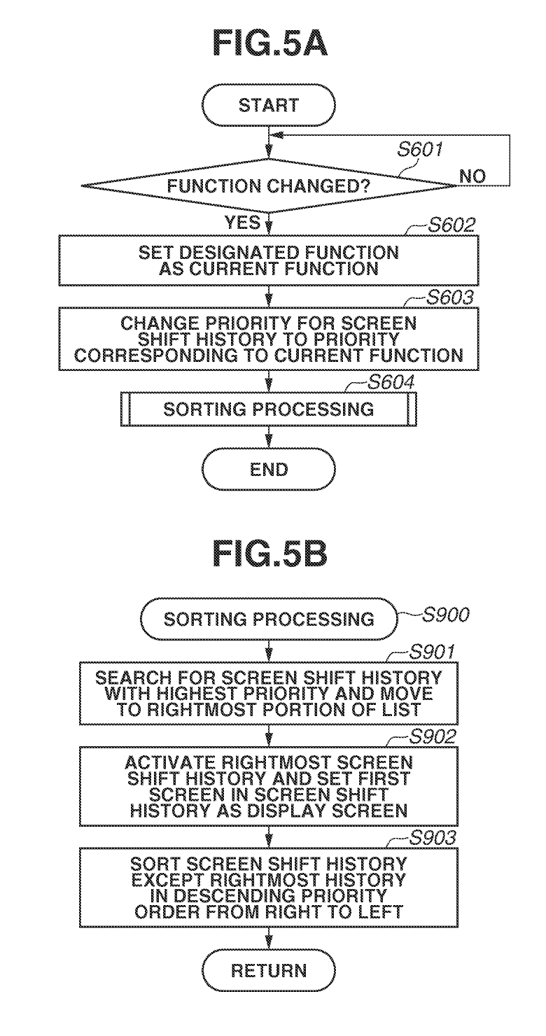

Now, processing executed by the control unit 102 when a function change has been detected will be described in detail below with reference to the flow chart in FIG. 5A. Referring to FIG. 5A, in step S601, the control unit 102 determines whether any function change based on an action of a screen shift has been detected. If it is determined that a function change has been detected (Yes in step S601), then the processing advances to step S602. On the other hand, if it is determined that no function change has been detected (No in step S601), then the processing in step S601 is repeated, and the control unit 102 waits until any action is detected.

In step S602, the control unit 102 sets the current function stored by the management unit 104 as a designated function. In step S603, the control unit 102 changes all the priority levels in the screen shift history stored by the management unit 104 to the priority corresponding to the current function. In step S604, the control unit 102 sorts out the priority levels in the screen shift history list stored by the management unit 104 according to the priority in the screen shift history.

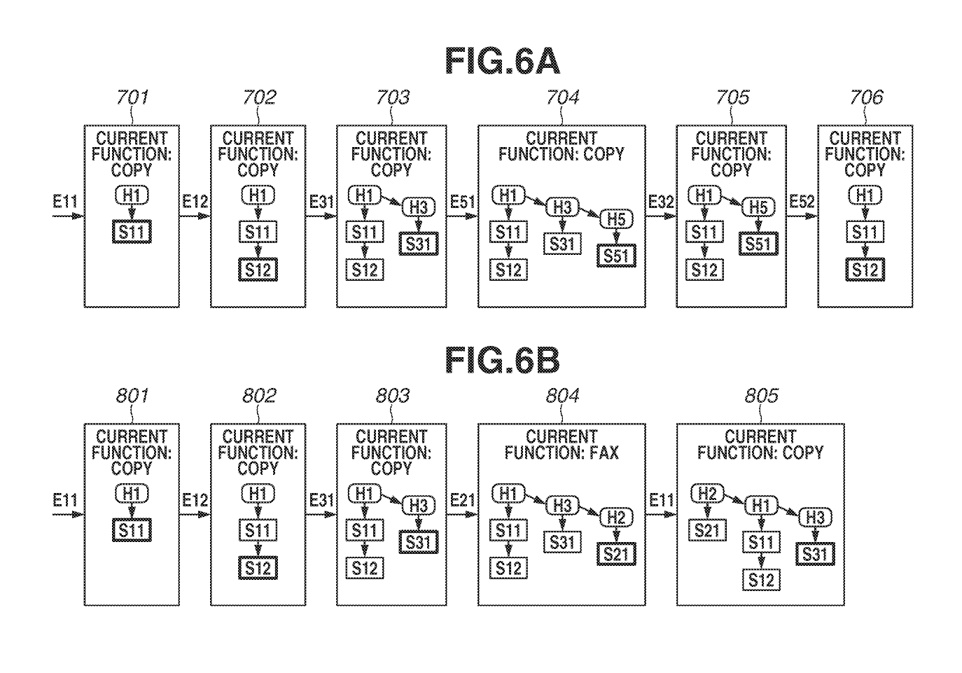

FIG. 6A is a schematic diagram illustrating an example of the screen shift history list (a list that manages the groups to which the UI screen corresponding to the currently existing event belongs). Referring to FIG. 6A, the management unit 104 stores a screen shift history list 701. When the screen is shifted to a UI screen included in a group, if no screen shift history corresponding to the group exists, a new screen shift history is generated and is added to the screen shift history list. On the other hand, if the screen shift history corresponding to the group already exists, information about the UI screen is added to the existing screen shift history.

In the example illustrated in FIG. 6A, the screen shift history of the groups G1 through G5 correspond to histories H1 through H5, respectively. The screen shift history lists are sorted according to the priority of the screen shift history in ascending order of priority levels from left to right. Among the screen shift histories, the first (displayed lowermost) UI screen (representative UI screen) indicates the currently displayed screen.

In the example illustrated in FIG. 6A, the screen shift history H1 is currently active. Accordingly, the copy basic screen S11, which is the first screen included in the screen shift history, is the currently displayed UI screen. Memory information about the UI screen can be used as the information about the UI screen to be stored in the screen shift history. Alternatively, a UI screen identifier only can be used as the information about the UI screen to be stored in the screen shift history.

The sorting processing in step S604 will be described in detail below with reference to the flow chart in FIG. 5B. Referring to FIG. 5B, in step S901, the control unit 102 preferentially searches for the screen shift history having the highest priority level among the screen shift history lists and moves the searched screen shift history to the rightmost portion of the screen shift history list. If a plurality of screen shift histories having the highest priority level exists, the control unit 102 moves the one existing rightmost of the plurality of screen shift histories having the highest priority level to the rightmost portion of the screen shift history list. In step S902, the control unit 102 activates the rightmost screen shift history, and executes the display control for setting the first UI screen of the screen shift history to be displayed on the display screen.

In step S903, the control unit 102 sorts out the screen shift histories except the rightmost screen shift history in ascending order of priority levels from left to right based on the priority of the screen shift history. Then the sorting ends. By preferentially moving the UI screen having the highest priority level in the above-described manner, the present exemplary embodiment can prevent the possibility that the display unit displays a UI screen included in the screen shift history having a lower priority while sorting the screen shift history list.

If a “print button” event has occurred in the example illustrated in FIG. 6A, the display screen shifts to the print screen S12 (the event E12). Because the print screen belongs to the same group (the copy group G1) as the group of the copy basic screen, the UI screen is added to the screen shift history H1 (screen shift history list 702) and the print screen S12 becomes a currently displayed screen.

If the screen is then shifted due to a “no-color toner” event (event E31), the screen shift is grouped into the color toner abnormality group G3. Accordingly, a new screen shift history H3 is generated, and the no-color toner screen S31 is added to the newly generated screen shift history H3 in its first portion (screen shift history list 703). As a result, the no-color toner screen S31 becomes the currently displayed screen. As described above, the copy function has the priority level 2 for the copy group G1 and the priority level 3 for the color toner abnormality group G3. Accordingly, the color toner abnormality group G3, which has the higher priority level of the two groups, is added to the rightmost portion of the list.

Further, if the display screen is shifted due to a “power abnormality” event (event E51), the shift is grouped into the critical error group G5. Accordingly, the critical error group G5 is added to the screen shift history list, and the power abnormality screen S51 is added to the screen shift history list in its first portion (screen shift history list 704). Accordingly, the power abnormality screen S51 becomes the current screen. The critical error group G5 has the priority level 4 for the copy function. Therefore, the screen shift history H5 is added to the right portion of the screen shift history list.

Subsequently but before the power abnormality is solved, if a color toner is replenished to the multifunction printer and a “replenished color toner” event has occurred, an action for deleting the screen shift history of the color toner abnormality group G3 (event E32) is executed. After deleting the screen shift history H3 corresponding to the color toner abnormality group G3, a screen shift history list 705 is generated. In this state, the first UI screen is not changed from that in the screen shift history list 704. Accordingly, the screen is not shifted.

When the power abnormality is solved and a “solved power abnormality” event has occurred, the deletion shift for deleting the screen shift history H5 in the critical error group G5 (event E52) is executed (screen shift history list 706). Accordingly, the UI screen S12 is displayed.

Now, processing executed when a function change is executed will be described in detail below with reference to FIG. 6B. Processing for screen shift history lists 801 through 803 is similar to the processing for the screen shift history lists 701 through 703 illustrated in FIG. 6A. Accordingly, the detailed description thereof will not be repeated.

If the user has pressed the FAX button of the multifunction printer when the screen shift history list 803 is currently stored and the display screen is shifted due to a “FAX button” event, the shift is grouped into the FAX group G2. Therefore, a screen shift history H2 is generated and stored in the screen shift history list. Further, the FAX basic screen S21 is added to the screen shift history list. The screen shift history H2 has the priority level 1 for the copy function. Accordingly, the screen shift history H2 is inserted into the screen shift history list in its leftmost portion.

However, since the event E21 has an action for changing the current function to the FAX function, the priority levels of the screen shift histories are sorted according to the priority level set to the FAX function. Thus, the screen shift histories are sorted in order of H1, H3, and H2 from left to right (having the priority levels 1, 1, and 2, respectively), as in a screen shift history list 804, and if no color toner exists in the multifunction printer, the FAX function can be used.

Suppose that the copy button of the multifunction printer is pressed and that the screen shift due to the “copy button” event (the event E11) has been executed. In this case, processing for generating a UI screen is not executed because the copy group G1 has already been included in the screen shift history list. However, because the event E11 includes an action for changing the current function to the copy function, the priority levels in the screen shift histories are sorted by the priority level set to the copy function. Accordingly, the screen shift histories are sorted in order of H2, H1, and H3 (corresponding to the priority levels 1, 2, and 3, respectively) from left to right, as in a screen shift history list 805. In a state for using the copy function, the no-color toner UI screen S31 is displayed.

With the above-described configuration, the present exemplary embodiment can easily implement a logic of complicated screen shifting including changing between UI screens corresponding to a function change by using a declarative description illustrated in FIG. 2. Accordingly, the present exemplary embodiment can effectively reduce the load of programming.

In the present exemplary embodiment, the multifunction printer is used as an example. However, the present invention can be implemented by a digital device which includes a display configured to display a plurality of UI screens that can be displayed by the screen shift.

The above-described first exemplary embodiment can implement the following screen shift. More specifically, a priority level of each operation mode is designated to each group having the UI screen used in exceptional occasions. Further, the screen shift histories are sorted in executing the operation according to the priority level. Thus, the priority level can be changed according to the operation mode. A second exemplary embodiment of the present invention can be applied when a UI screen for user authentication is used in addition to the UI screens used in exceptional states.

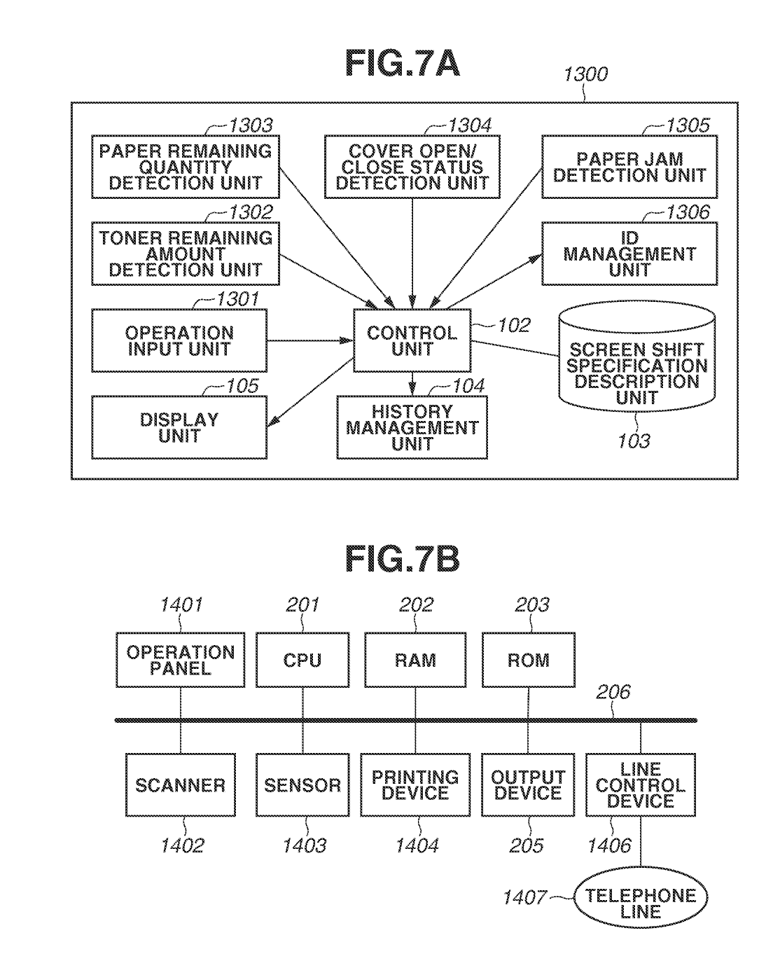

In the second exemplary embodiment, a multifunction printer which has three functions including the copy function, the FAX function, and a scan function will be described as an example. FIG. 7A is a functional block diagram of the multifunction printer, which is an example of the information processing apparatus according to the present exemplary embodiment. Referring to FIG. 7A, the multifunction printer includes a control unit 102, a screen shift specification description unit 103, a management unit 104, and a display unit 105. In addition, the multifunction printer includes an operation input unit 1301, a toner remaining amount detection unit 1302, a sheet remaining quantity detection unit 1303, a cover open/close status detection unit 1304, a paper jam detection unit 1305, and an identifier (ID) management unit 1306.

The control unit 102 is constituted by a CPU 201, reads a program and data from a ROM 203 on a RAM 202, and executes various processing on the RAM 202. The screen shift specification description unit 103 is constituted by a storage medium, such as the ROM 203. On the screen shift specification description unit 103, screen shift specification data necessary for executing the program is stored as computer (including a CPU)-readable program codes.

The management unit 104 is constituted by the RAM 202 and manages history information about a screen shift. The display unit 105 includes an output device 205, such as an LCD, and displays various information pieces including an image and text data. The operation input unit 1301 is constituted by a plurality of buttons provided on an operation panel 1401 and receives a user input. The toner remaining amount detection unit 1302 receives toner remaining amount information from a sensor 1403. The sheet remaining quantity detection unit 1303 receives sheet remaining quantity information from the sensor 1403.

The cover open/close status detection unit 1304 receives a printer housing cover open/close status from the sensor 1403. The paper jam detection unit 1305 receives a paper jam status in a printing device 1404 of the multifunction printer from the sensor 1403. The ID management unit 1306 is constituted by the RAM 202 and manages authentication information. The authentication information includes a user ID, a division ID, and a password. “Authentication” refers to identification of a user or restriction of use of the multifunction printer based on the above-described information.

FIG. 7B illustrates an exemplary hardware configuration of the multifunction printer, which is an example of the information processing apparatus according to the present exemplary embodiment. Components according to the present exemplary embodiment similar to those described above with reference to the functional block diagram of FIG. 7A are provided with the same reference numerals and symbols. Accordingly, the detailed description thereof will not be repeated. Referring to FIG. 7B, the multifunction printer includes a CPU 201, a RAM 202, a ROM 203, an output device 205, a system bus 206, an operation panel 1401, a scanner 1402, a sensor 1403, the printing device 1404, a line control device 1406, and a telephone line 1407.

The output device 205 includes a display unit, such as an LCD. The system bus 206 connects the components of the multifunction printer. Via the system bus 206, signals can be transmitted and received among the components of the multifunction printer. The operation panel 1401 includes a copy button for enabling the copy function and a start button for starting printing. The scanner 1402 reads information of a document set on a document stand. The printing device 1404 outputs data by printing the data on paper. In using the FAX function, the line control device 1406 transmits and receives data via the telephone line 1407.

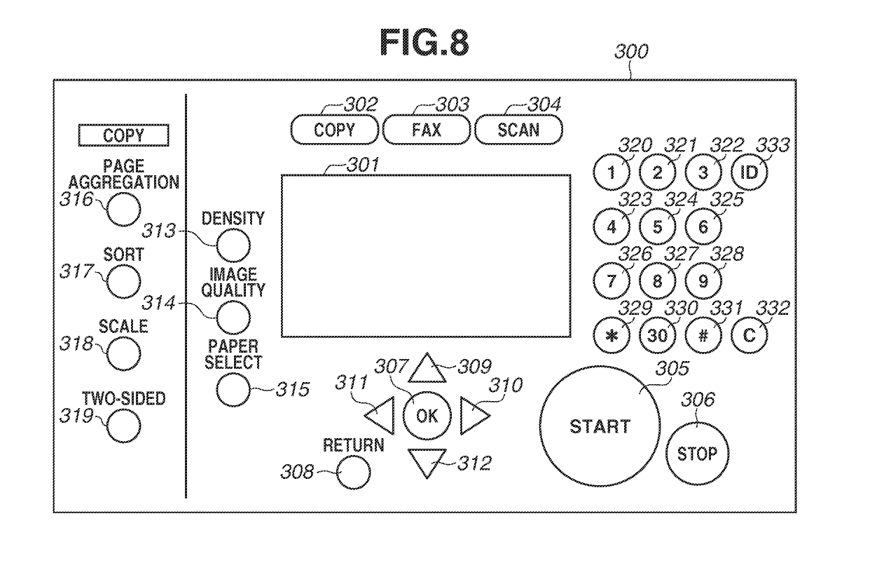

FIG. 8 illustrates the operation panel 1401, which corresponds to the operation input unit 1301, and a panel of the multifunction printer constituted by the output device 205, which corresponds to the display unit 105. Referring to FIG. 8, a copy button 302 can be operated to enable the copy function. A FAX button 303 can be operated to enable the FAX function. A scan button 304 can be operated to enable the scan function. A start button 305 can be operated to actually start a copy job, a FAX job, or a scan job. A stop button 306 can be operated to stop the currently executed task. An OK button 307 can be operated to determine an item from among selection items displayed on the display portion. A return button 308 can be operated to return to a previous UI screen according to the screen shift history.

Each of an up button 309, a right button 310, a left button 311, and a down button 312 can be operated to move a selected position on a plurality of items displayed on the display portion. A density button 313 can be operated to change the density of the LCD. An image quality button 314 can be operated to set the image quality level of the document. A sheet selection button 315 can be operated to designate the size of the sheet to be used.

Buttons 316 through 319 are used when the copy function is set as the current function. The button 316 can be operated to execute a designation for aggregating a plurality of pages into one page. The button 317 can be operated to designate a sorting method when a plurality of copies is to be printed. The button 318 can be operated to designate magnification or reduction of a page to be printed. The button 319 is used to designate two-sided printing in printing a page.

Buttons 320 through 331 are numerical value buttons and sign buttons, which can be used to designate the number of copies in a copy job, to input a FAX number in a FAX job, and to designate an authentication ID in authenticating a user. A clear button 332 can be operated to cancel an input numerical value. An ID button 332 can be operated to execute the user authentication for a function to be executed.

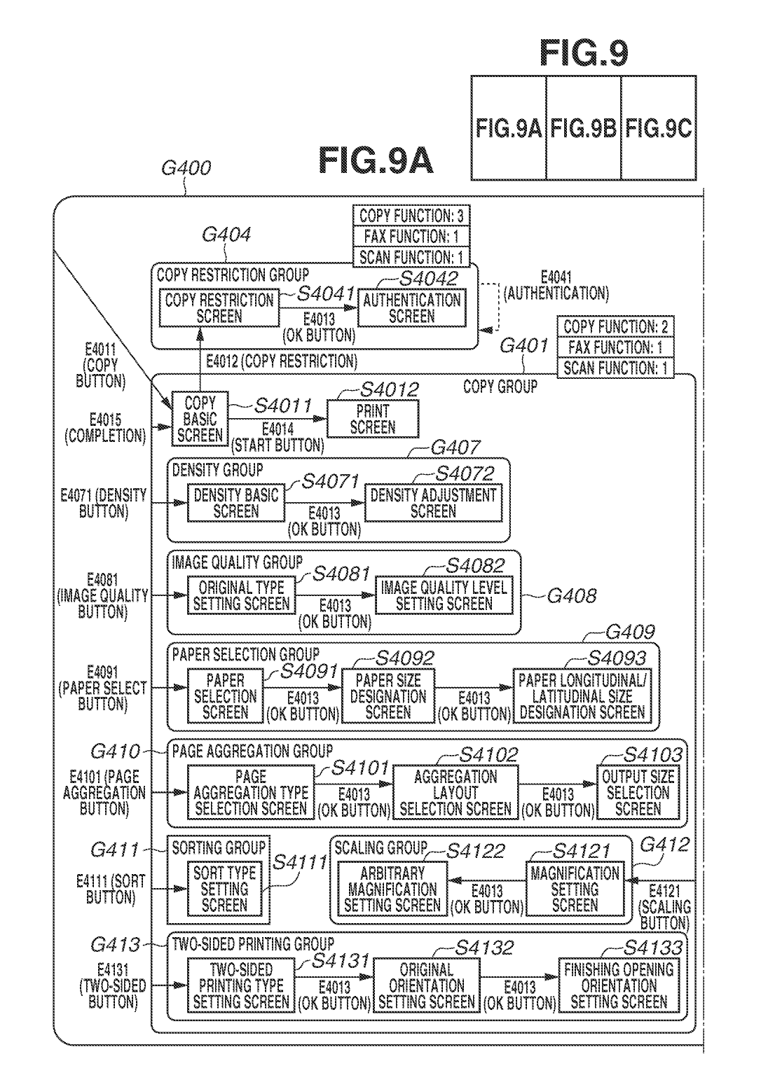

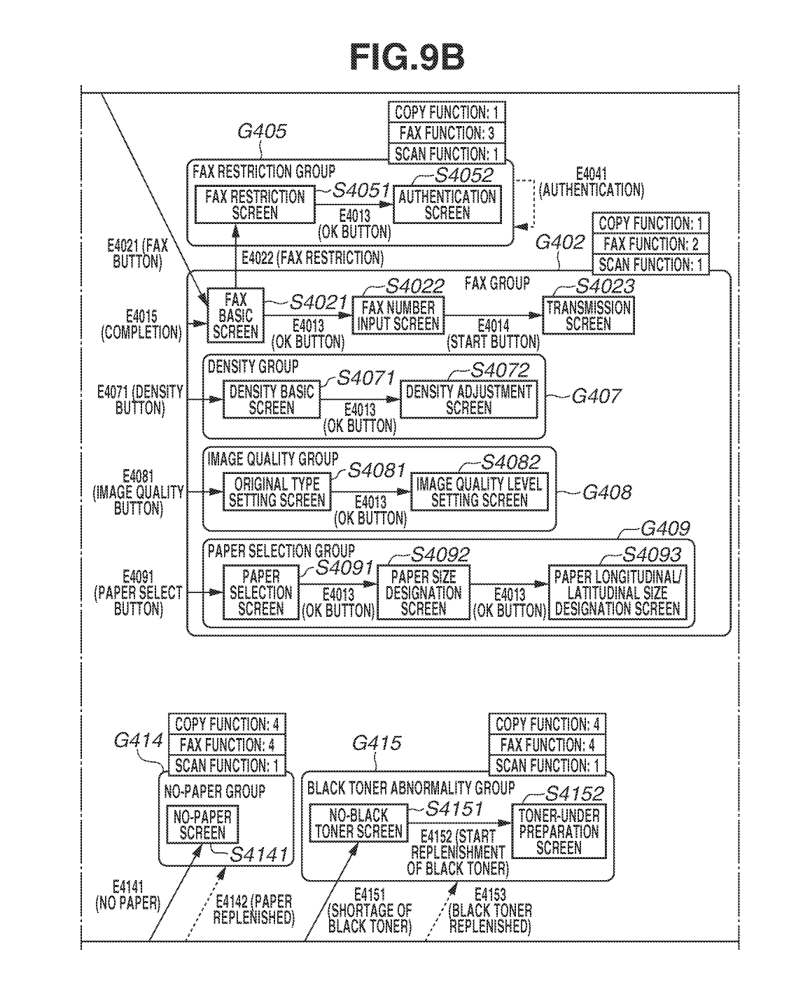

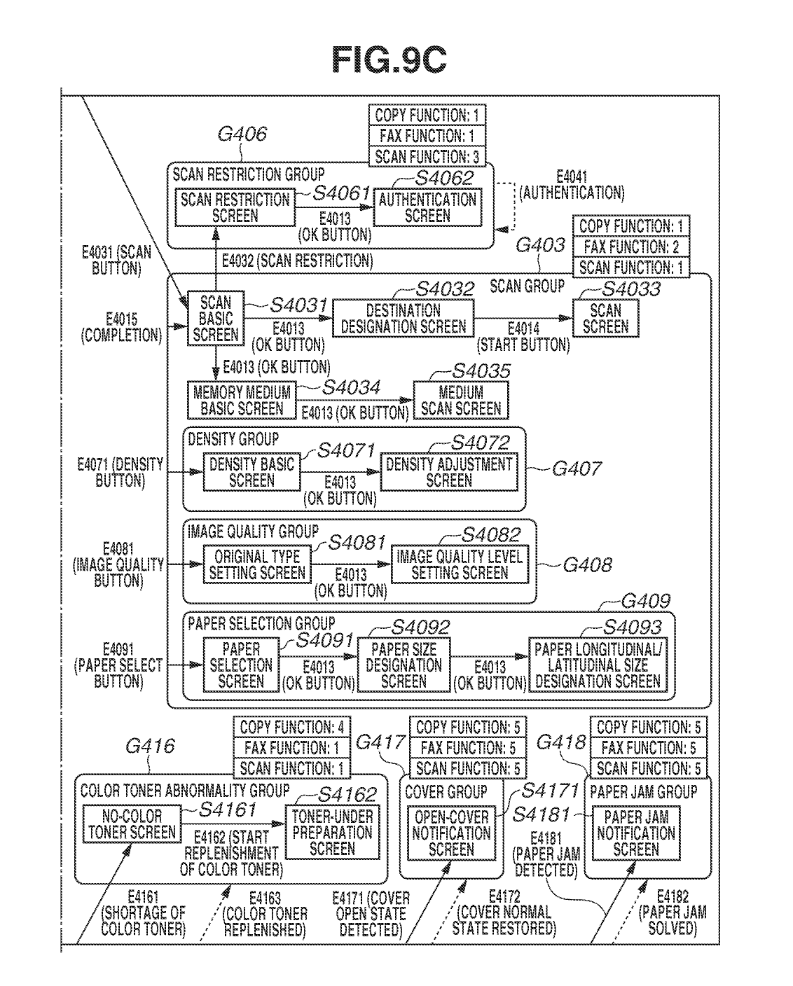

Now, an example of a screen shift executed by the multifunction printer will be described in detail below with reference to FIG. 9 (including FIGS. 9A to 9C). FIGS. 9A to 9C are the screen shift diagram illustrating an exemplary screen shift specification. Referring to FIGS. 9A to 9C, there is a group G400, which collectively indicates the entire group. The group G400 includes normal event groups, such as a copy group G401, a FAX group G402, a scan group G403, a copy restriction group G404, a FAX restriction group G405, and a scan restriction group G406. In addition, the group G400 includes groups used in exceptional occasions, such as a no-paper group G414, a black toner abnormality group G415, a color toner abnormality group G416, a cover group G417, and a paper jam group G418.

Each of the COPY group, the FAX group, and the SCAN group includes groups therein. In other words, a density group G407, an image quality group G408, and a sheet selection group G409 are included in common to the COPY, FAX, and SCAN groups. Groups uniquely included in the COPY group are a page aggregation group G410, a sorting group G411, a scaling group G412, and a two-sided printing group G413. In FIGS. 9A to 9C, for the group to which the function-unique priority level is added to the upper-right thereof, the priority can be changed according to the current function. On the other hand, the priority of a higher-order group is applied to the group to which no function-unique priority level is added.

The copy group G401 has the priority level 2 for the copy function, and the priority level 1 for each of the FAX function and the scan function. Similarly, the FAX group G402 has the priority level 1 for the copy function, the priority level 2 for the FAX function, and the priority level 1 for the scan function. The scan group G403 has the priority level 1 for the copy function and the FAX function, and the priority level 2 for the scan function. The copy restriction group G404 has the priority level 3 for the copy function, the priority level 1 for the FAX function and the scan function. The FAX restriction group G405 has the priority level 1 for the copy function, the priority level 3 for the FAX function, and the priority level 1 for the scan function. The scan restriction group G406 has the priority level 1 for the copy function and the FAX function, and the priority level 3 for the scan function.

The no-paper group G414 has the priority level 4 for the copy function and the FAX function, and the priority level 1 for the scan function. The black toner abnormality group G415 has the priority level 4 for the copy function and the FAX function, and the priority level 1 for the scan function. The color toner abnormality group G416 has the priority level 4 for the copy function, and the priority level 1 for the FAX function and the scan function. The cover group G417 has the priority level 5 for the copy function, the FAX function, and the scan function, respectively. The paper jam group G418 has the priority level 5 for the copy function, the FAX function, and the scan function, respectively.

The UI screen includes a copy basic screen S4011 and a print screen S4012 as the screens of the copy group. The UI screen includes a FAX basic screen S4021, a FAX number input screen S4022, and a FAX transmission screen S4023 as the screens of the FAX group. The UI screen includes a scan basic screen S4031, a destination designation screen S4032, a scan screen S4033, a memory medium basic screen S4034, and a medium scanning screen S4035 as the screens of the scan group.

For the screens of the copy restriction group, a copy restriction screen S4041 and an authentication screen S4042 are included. For the screens of the FAX restriction group, a FAX restriction screen S4051 and an authentication screen S4052 are included. The scan restriction group includes screens, such as a scan restriction screen S4061 and an authentication screen S4062.

A density basic screen S4071 and a density adjustment screen S4072 are included in the density group. The image quality group includes an original type setting screen S4081 and an image quality level setting screen S4082. The paper selection group includes screens, such as a paper selection screen S4091, a paper size designation screen S4092, and a paper longitudinal/latitudinal size designation screen S4093.

The page aggregation group includes a page aggregation type selection screen S4101, an aggregation layout selection screen S4102, and an output size selection screen S4103. The sorting group includes a sort type setting screen S4111. The scaling group includes screens, such as a magnification setting screen S4121 and an arbitrary magnification setting screen S4122. The two-sided printing group includes a two-sided printing type selection screen S4131, an original orientation setting screen S4132, and a finishing opening orientation setting screen S4133.

The no-paper group includes a no-paper screen S4141. The black toner abnormality group includes a no-black toner screen S4151 and a toner under preparation screen S4152. The color toner abnormality group includes a no-color toner screen S4161 and a toner under preparation screen S4162. The cover group includes an open cover screen S4171. The paper jam group includes a paper jam screen S4181.

In the example illustrated in FIGS. 9A to 9C, solid line and broken-line arrows have the same meaning as those in the first exemplary embodiment. The screen shift primarily includes a screen shift executed when the copy button is pressed (event E4011), a screen shift executed when the FAX button is pressed (event E4021), and a screen shift executed when the scan button is pressed (event E4031). In addition, the screen shift includes a screen shift executed when the OK button is pressed (event E4013) and a screen shift executed when the start button is pressed (event E4014). A screen shift related to user restriction includes events E4012, E4022, and E4032, which are screen shifts started as internal events when the copy function, the FAX function, or the scan function is restricted.

A screen shift executed commonly to the copy group, the FAX group, and the scan group includes the screen shift executed when the density button 313 is pressed (event E4071), a screen shift executed when the image quality button 314 is pressed (event E4081), and a screen shift executed when the sheet selection button 315 is pressed (event E4091). A screen shift executed related uniquely to the copy function includes a screen shift executed when the page aggregation button 316 is pressed (event E4101), a screen shift executed when the sorting button 317 is pressed (event E4111), a screen shift executed when the scaling button 318 is pressed (event E4121), and a screen shift executed when the two-sided printing button 319 is pressed (event E4131).

In each of the copy group, the FAX group, and the scan group, a screen shift which is an internal event E4015 is started when printing, FAX transmission, or scanning is completed or various settings, such as the setting of the density, is completed. A screen shift that is executed under exceptional occasions includes a screen shift executed when the no-paper state is detected (event E4141), a screen shift executed when the no-black toner state is detected (event E4151), a screen shift executed when the no-color toner state is detected (event E4161), a screen shift executed when the cover-open state is detected (event E4171), and a screen shift executed when a paper jam is detected (event E4181). Each of events E4152 and E4162 is a screen shift started as an internal event when the black toner or the color toner is replenished to the multifunction printer.

The deletion shift includes a deletion shift executed when the paper-replenished state is detected (event E4142), a deletion shift executed when the black toner-replenished state is detected (event E4153), a deletion shift executed when the color toner-replenished state is detected (event E4163), a deletion shift executed when the cover-closed state is detected (event E4172), and a deletion shift executed when the jam-eliminated state is detected (event E4182). Each of the copy restriction group, the FAX restriction group, and the scan restriction group includes a deletion shift executed when the user authentication is normally completed (event E4041).

In the present exemplary embodiment, a function changing action for changing the current function to the copy function, the FAX function, and the scan function is set as events E4011, E4021, and E4031, respectively. The control unit 102 loads and executes the screen shift specification data illustrated in FIGS. 9A to 9C on the RAM 202.

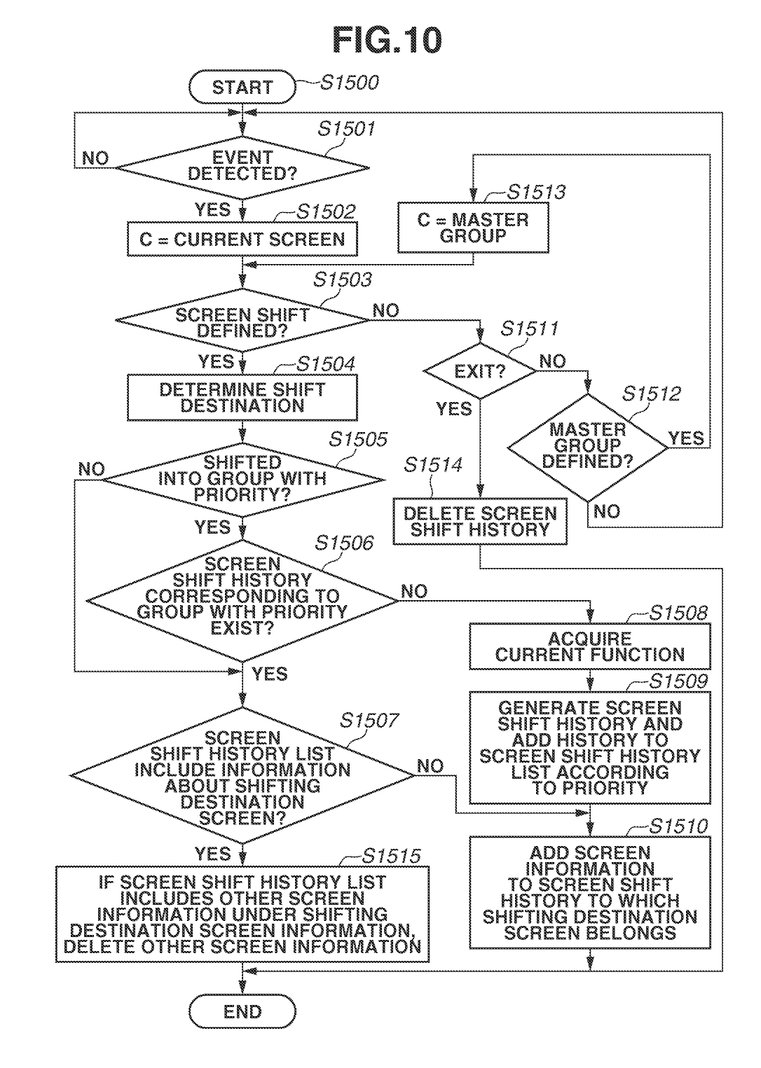

Now, processing executed by the control unit 102 when an operation that is the trigger of a screen shift is detected will be described in detail below with reference to the flow chart in FIG. 10. Referring to FIG. 10, in step S1501, the control unit 102 determines whether an operation that is the trigger of a screen shift (i.e., a user operation for pressing the button, an event caused by the sensor, or the internal event) has been detected. If an event like this has been detected (Yes in step S1501), then the processing advances to step S1502. On the other hand, if no such event has been detected (No in step S1501), then the control unit 102 waits until an event is detected.

In step S1502, the control unit 102 sets the UI screen displayed on the display unit 105 (the shift source UI screen) as the reference of the screen shift. In step S1503, the control unit 102 determines, with respect to the shift source UI screen, whether the screen shift executed due to the event detected in step S1501 has been defined in the screen shift specification data. If it is determined that predetermined data has been defined in the screen shift specification data (Yes in step S1502), then the processing advances to step S1504. On the other hand, if it is determined that the predetermined data has not been defined in the screen shift specification data (No in step S1502), then the processing advances to step S1511.

In step S1504, the control unit 102 determines the shift destination UI screen according to the definition in the screen shift specification data. In step S1505, the control unit 102 determines whether the screen shift is a shift into a priority-added group to which the shift destination UI screen belongs. If it is determined that the screen shift is a shift into a priority-added group (Yes in step S1505), then the processing advances to step S1506. On the other hand, if it is determined that the screen shift is not a shift into a priority-added group (No in step S1505), then the processing advances to step S1507.

In step S1506, the control unit 102 determines whether any screen shift history corresponding to the priority-added group including the shift destination UI screen is included in the screen shift history list managed by the management unit 104. If the screen shift history list includes the corresponding screen shift history (Yes in step S1506), then the processing advances to step S1507. On the other hand, if the screen shift history list does not include the corresponding screen shift history (No in step S1506), then the processing advances to step S1508.

In step S1507, the control unit 102 determines whether screen information corresponding to the shift destination UI screen is included in the screen shift history list managed by the management unit 104. If the screen shift history list includes the corresponding screen information (Yes in step S1507), then the processing advances to step S1515. On the other hand, if the screen shift history list does not include the corresponding screen information (No in step S1507), then the processing advances to step S1510.

In step S1515, if any other UI screen information exists under UI screen information about the shift destination UI screen included in the screen shift history list managed by the management unit 104, the control unit 102 deletes the UI screen information. Then the processing ends.

In step S1508, the control unit 102 acquires the current function from the screen shift history list managed by the management unit 104. In step S1509, the control unit 102 generates a screen shift history having a function-unique priority level corresponding to the current function in the group to which the shift destination UI screen belongs. The generated screen shift history is added to the screen shift history list managed by the management unit 104. In step S1510, the control unit 102 adds the UI screen information of the current UI screen to the screen shift history corresponding to the group to which the shift destination UI screen belongs.

In step S1511, the control unit 102 determines whether the deletion shift indicated with the broken-line arrow illustrated in FIG. 3 has been defined. If it is determined that the deletion shift has been defined (Yes in step S1511), then the processing advances to step S1514. On the other hand, if it is determined that the deletion shift has not been defined (No in step S1511), then the processing advances to step S1512.

In step S1514, the control unit 102 deletes the screen shift history, which corresponds to the group to be deleted, from the screen shift history list managed by the management unit 104. Then the processing ends.

In step S1512, the control unit 102 determines whether the master group has been defined on the shift source UI screen. If it is determined that the master group has been defined on the shift source UI screen (Yes in step S1512), then the processing advances to step S1513. On the other hand, if it is determined that no master group has been defined on the shift source UI screen (No in step S1512), then the processing returns to step S1501 and the control unit 102 waits until an event is detected.

In step S1513, the control unit 102 sets the detected master group as the reference of the screen shift. Then the control unit 102 executes the processing in step S1503 and beyond under determination that the master group is the shift source UI screen.

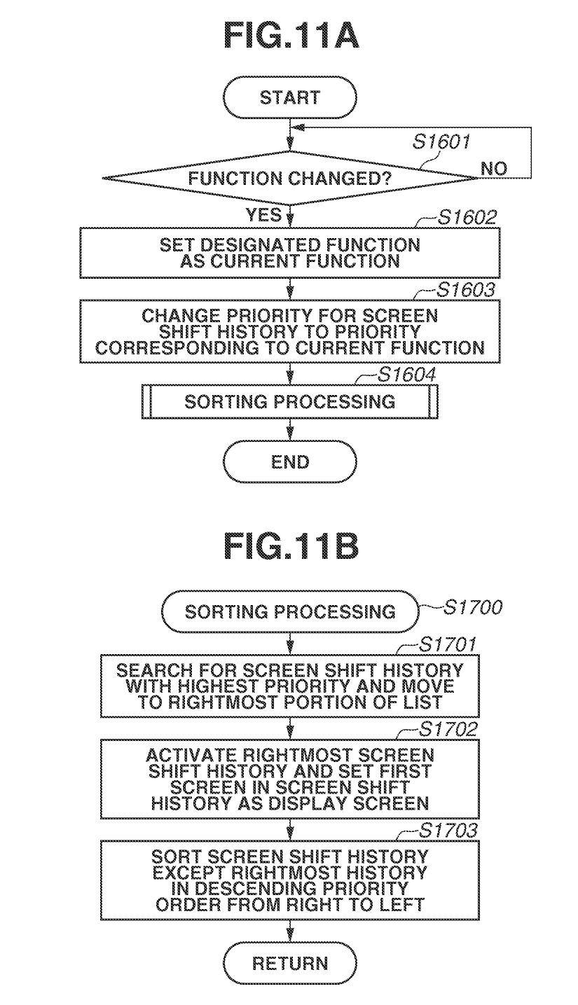

Now, processing executed by the control unit 102 when a change of functions has been detected will be described in detail below with reference to the flow chart in FIG. 11A. Referring to FIG. 11A, in step S1601, the control unit 102 determines whether any function changing due to an action of screen shift has been detected. If it is determined that a function change has been detected (Yes in step S1601), then the processing advances to step S1602. On the other hand, if it is determined that no function change has been detected (No in step S1601), then the processing in step S1601 is repeated, and the control unit 102 waits until any action is detected.

In step S1602, the control unit 102 sets the current function stored by the management unit 104 as a designated function. In step S1603, the control unit 102 changes all the priority levels in the screen shift history stored by the management unit 104 to the priority corresponding to the current function. In step S1604, the control unit 102 sorts out the priority levels in the screen shift history list stored by the management unit 104 according to the priority in the screen shift history.

The sorting executed in step S1604 will be described in detail below with reference to the flow chart in FIG. 11B. Referring to FIG. 11B, in step S1701, the control unit 102 preferentially searches for the screen shift history having the highest priority level among the histories in the screen shift history lists and sets the extracted screen shift history to the rightmost portion of the screen shift history list. If a plurality of screen shift histories having the highest priority level exists, the control unit 102 moves the one existing rightmost among the plurality of screen shift histories to the rightmost portion of the screen shift history list.

In step S1702, the control unit 102 activates the rightmost screen shift history, and sets the first UI screen of the screen shift history to be displayed on the display screen. In step S1703, the control unit 102 sorts out the screen shift histories except the rightmost screen shift history in ascending order of priority levels from left to right based on the priority of the screen shift history. Then the sorting ends.

By preferentially moving the UI screen having the highest priority level in the above-described manner, the present exemplary embodiment can prevent the possibility that the display unit displays a UI screen included in the screen shift history having a lower priority while sorting the screen shift history list.

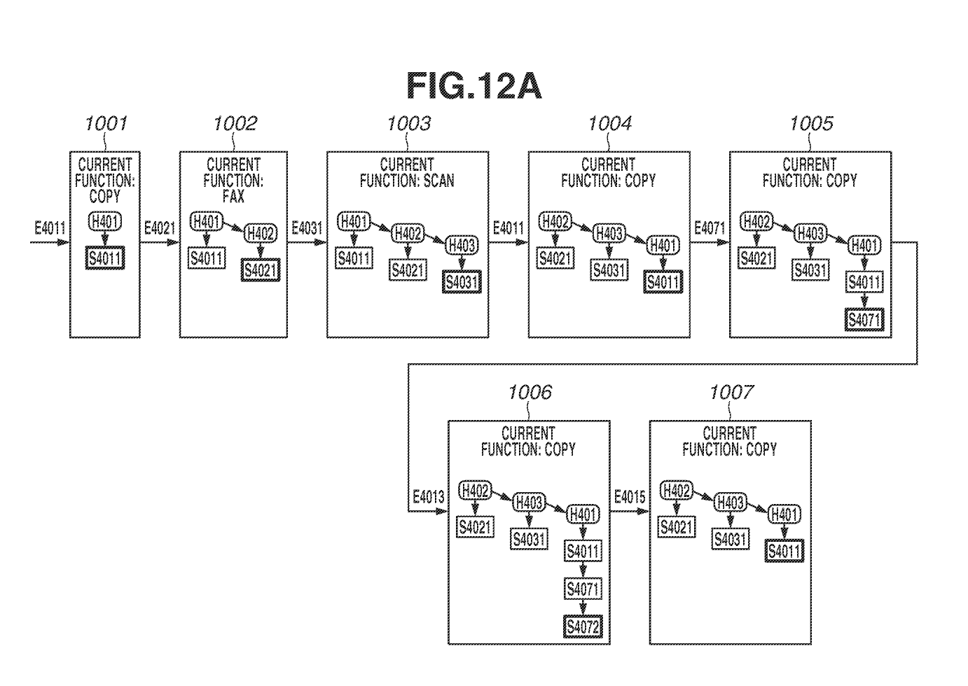

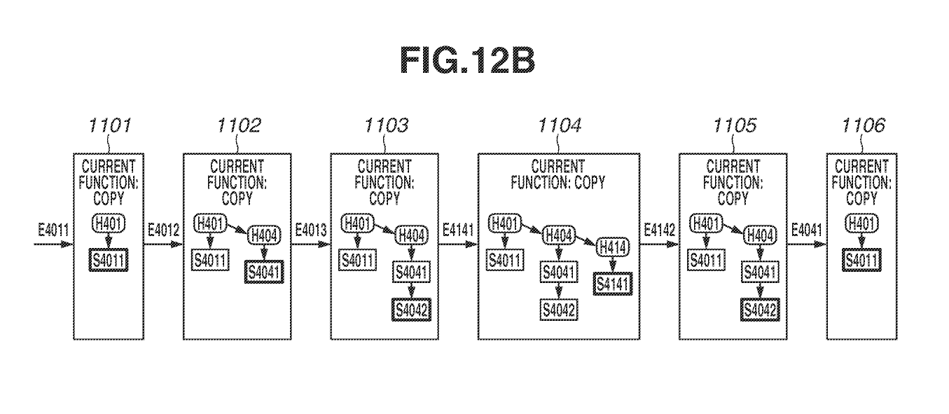

FIGS. 12A and 12B are schematic diagrams illustrating an example of a screen shift history list used by the multifunction printer. The behavior of the screen shift history list is the same as the first exemplary embodiment. In the example illustrated in FIGS. 12A and 12B, the screen shift history of the groups G401 through G406 correspond to histories H401 through H406, respectively. Similarly, the screen shift history of the groups G414 through G418 correspond to histories H414 through H418.

If a FAX button event has occurred in a state of a screen shift history list 1001 in FIG. 12A, a screen shift to the FAX basic screen S4021 (event E4021) is executed. The FAX basic screen belongs to the FAX group G402, which is different from the group including the copy basic screen. Accordingly, a screen shift history H402 is newly generated and the screen S4021 is added to the screen shift history H402 in its first portion.

The event E4021 has an action for changing the current function to the FAX function. Therefore, the priority levels set to the screen shift histories are sorted according to the priority level set for the FAX function. For the FAX function, the group G401 has the priority level 1 and the group G402 has the priority level 2. Accordingly, the screen shift history H402 is moved to the right. Therefore, the screen S4021 becomes the current screen (a screen shift history list 1002). In the above-described manner, when the FAX button is pressed, the display screen shifts to the UI screen that enables the user to use the FAX function.

When a scan button event has occurred, the display screen shifts to the scan basic screen S4031 (the event E4031). Similarly to the case of the event E4021, because the scan basic screen belongs to the scan group G403, which is different from the group including the FAX basic screen, a screen shift history H403 is newly generated. Further, the screen S4031 is added to the screen shift history H403 in its first portion.

Because the event E4031 has an action for changing the current function to the scan function, the priority levels set to the screen shift histories are sorted according to the priority level set for the scan function. For the scan function, the groups G401 and G402 have the priority level 1, and the group G403 has the priority level 2. Accordingly, the screen shift history H403 is moved to the right, and the screen S4031 becomes the current screen (a screen shift history list 1003). In the above-described manner, when the scan button is pressed, the screen shift to the screen that enables the user to execute scanning is executed.

If a copy button event has occurred, the display screen shifts to the copy basic screen S4011 (the event E4011). Because the screen shift history H401 which includes the copy basic screen S4011 and the screen S4011 itself have already been added to the screen shift history list, the screen shift history list remains in the state as it is.

Because the event E4011 has an action for changing the current function to the copy function, the priority levels set to the screen shift histories are sorted according to the priority level set for the copy function. For the copy function, the group G401 has the priority level 2, and the groups G402 and G403 have the priority level 1. Accordingly, the screen shift history H401 is moved to the rightmost position in the list. Therefore, the screen S4011 becomes the current screen (a screen shift history list 1004).

Then if a density button event has occurred due to the pressing of the density button 313, the display screen shifts to the density basic screen S4071 (the event E4071). Because the screen shift history H401, to which the density basic screen S4071 belongs, has already been stored but no UI screen information has been added, the UI screen information about the density basic screen S4071 is added to the screen shift history H401. Accordingly, the density basic screen S4071 becomes the current screen (a screen shift history list 1005).

If an OK button event has occurred due to the pressing of the OK button 307, the display screen shifts to the density adjustment screen S4072 (the event E4013). Because the screen shift history H401, to which the density adjustment screen S4072 belongs, has already been stored but no UI screen information has been added, the UI screen information about the density adjustment screen S4072 is added to the screen shift history H401. Accordingly, the density adjustment screen S4072 becomes the current screen (a screen shift history list 1006).

Next, if a completion event has occurred due to the completion of the density adjustment, the display screen shifts to the copy basic screen S4011 (the event E4015). Because the screen shift history H401, to which the copy basic screen S4011 belongs, and the information about the copy basic screen S4011 have already been added to the screen shift history list. However, the UI screen information exists under the copy basic screen S4011, the UI screen information is deleted as described above. Accordingly, the screen S4011 becomes the current screen (a screen shift history list 1007).

Exemplary processing executed when an error screen is displayed when the authentication screen is currently displayed will be described in detail below with reference to FIG. 12B. In the example illustrated in FIG. 12B, in a state 1101, the control unit 102 determines that the copy function has been restricted according to the information acquired from the ID management unit 1306. When the copy restriction is executed, the display screen shifts to the copy restriction screen S4041 (the event E4012).

The copy restriction screen belongs to the copy restriction group G404, which is different from the group including the copy basic screen. Accordingly, a screen shift history H404 is newly generated and stored in the screen shift history list. Further, the copy restriction screen S4041 is added to the history H404 in its first portion. Then the copy restriction screen S4041 becomes the current screen (a screen shift history list 1102).

Then if an OK button event has occurred due to the pressing of the OK button 307, the display screen shifts to the authentication screen S4042 (the event E4013). Because the screen shift history H404 including the authentication screen S4042 has already been stored in the screen shift history list but no screen information has been added, the screen information about the authentication screen S4042 is added to the screen shift history H404. Accordingly, the authentication screen S4042 becomes the current screen (a screen shift history list 1103).

The user can input authentication information via the authentication screen. At this time, the control unit 102 can store the currently input authentication information together with the screen information about the authentication screen included in the screen shift history H404.

Then a FAX receiving operation is executed by background of the authentication screen and the received data is printed. In this case, if the control unit 102 has received a signal indicating the no-paper state from the sheet remaining quantity detection unit 1303, the display screen shifts to the no-paper screen S4141 (the event E4141). Because the no-paper screen belongs to the no-paper group G414, which is different from the group including the authentication screen, anew screen shift history H414 is generated and stored. Further, the no-paper screen S4141 is added to the screen shift history H414 in its first portion. Accordingly, the no-paper screen S4141 becomes the current screen (a screen shift history list 1104).

If the control unit 102 has detected that the sheet has been replenished, the deletion shift for the replenished paper event (the event E4142) occurs. Thus, the screen shift history H414, which corresponds to the no-paper group G414 is deleted, and the first UI screen returns to the authentication screen S4042 (a screen shift history list 1105).

If the authentication information has been stored together with the UI screen information, when the first UI screen has returned to the authentication screen S4042, the control unit 102 acquires the authentication information from the management unit 104 and substitutes the authentication information on the display screen into an input form. As described above, the present exemplary embodiment stores information about a specific UI screen during a screen shift and returns the stored information when the display screen returns to the specific UI screen by the screen shift. In this manner, the present exemplary embodiment can reproduce the display state before the screen shift.

When all authentication information pieces are input, the authentication processing is completed. Accordingly, an authentication event occurs and the screen shift history H404, which corresponds to the copy restriction group G404, is deleted. Therefore, the copy basic screen S4011 becomes the current screen (a screen shift history list 1106).

With the above-described configuration, the present exemplary embodiment, which uses the declarative description illustrated in FIGS. 9A to 9C, can execute a screen shift if the UI screen used in the exceptional occasions and the UI screen for user authentication are included in different groups having different priority levels for different operation modes.

Aspects of the present invention can also be realized by a computer of a system or apparatus (or devices such as a CPU, a micro processing unit (MPU), and/or the like) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., a computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-169699 filed Jul. 28, 2010, No. 2011-079368 filed Mar. 31, 2011, and No. 2011-103006 filed May 2, 2011, which are hereby incorporated by reference herein in their entirety.

What is claimed is:

1. An information processing apparatus configured to display a user interface (UI) screen on a display unit, the information processing apparatus including:
an acquisition unit configured to acquire data that includes a plurality of groups to which a priority level corresponding to each of a plurality of modes is set and at least one UI screen is classified into each of the plurality of groups;
a storage unit configured to store the at least one UI screen classified into at least one group among the plurality of groups;
an identification unit configured to identify a mode; and
a display control unit configured to cause the display unit to display a UI screen that is representative of a group having a highest priority level for the mode identified by the identification unit among groups into which the at least one UI screen stored by the storage unit is classified.

2. The information processing apparatus according to claim 1, wherein a first priority level corresponding to a first mode, a second priority level corresponding to a second mode, and a third priority level corresponding to a third mode are set to each of the plurality of groups.

3. The information processing apparatus according to claim 2, wherein the first mode is an operation mode corresponding to a copy function, the second mode is an operation mode corresponding to a facsimile function, and the third mode is an operation mode corresponding to a scan function.

4. A method for controlling an information processing apparatus configured to display a user interface (UI) screen on a display unit, the method comprising:
acquiring data that includes a plurality of groups to which a priority level corresponding to each of a plurality of modes is set and at least one UI screen is classified into each of the plurality of groups;
storing the at least one UI screen classified into at least one group among the plurality of groups;
identifying a mode; and
causing the display unit to display a UI screen that is representative of a group having a highest priority level for the identified mode among groups into which the stored at least one UI screen is classified.

5. A computer-readable storage medium storing a program which causes a computer to execute a method according to claim 4.
